(19) United States
(12) Patent Application Publication
(10) Pub. No.: US 2010/0010906 A1
(43) Pub. Date: Jan. 14, 2010

(54) Point of sale payment method for multiple recipients using a digital payment service

(75) Inventor: William Grecia, Brooklyn, NY (US)

Correspondence Address: William Grecia, 932 East 79th Street, Brooklyn, NY, 11236, US

(73) Assignee: William Grecia, Brooklyn, NY (US)

(21) Appl. No.: 12/550,384

(22) Filed: Aug. 30, 2009

Related U.S. Application Data
(63) Continuation-in-part of application No. 11/934,775, filed on Nov. 4, 2007, now abandoned.
Application No. 11/934,775 is a continuation-in-part of application No. 11/625,836, filed on Jan. 23, 2007, now abandoned.

(51) Int. Cl. G06Q 20/00; G06F 15/16; G06Q 30/00

(52) U.S. Cl. 705/21; 705/40; 709/204

(57) ABSTRACT

The method allows the funds from the purchase of a single item to be automatically divided and distributed to multiple recipients according to pre-arranged royalty and percent ownership arrangements. The purchase of multiple items can also be managed this way. In one embodiment, the method may employ JavaScript fee-split code that can be uploaded from a remote merchant server. The code can be executed within the web browser of a buyer's computerized device, and then send instructions over the Internet to the API of an automated Internet ecommerce system. The ecommerce system will then automatically split the buyer's single item payment to multiple recipients, and automatically credit the escrow account of the multiple recipients at the time of the buyer's purchase. In another embodiment, the details of the fee split arrangement can be stored in the remote ecommerce system, and be automatically invoked when the user makes a purchase.

### CROSS-REFERENCE TO RELATED APPLICATIONS

This application is a continuation in part of, and claims the priority benefit of, U.S. patent application Ser. No. 11/934,775 “Point of sale payment system for multiple recipients using a digital payment service”, filed Nov. 4, 2007. This application is also a continuation in part of, and claims the priority benefit of, U.S. patent application Ser. No. 11/625,836, “Point of sale payment system for multiple recipients using a digital payment service”, filed Jan. 23, 2007. The contents of both Ser. Nos. 11/934,775 and 11/625,836 are incorporated herein by reference.

### BACKGROUND OF THE INVENTION

1. Field of the Invention

The invention presented in this document relates to the field of point-of-sale payment distribution using ecommerce services based on an application programmable interface (API), usually utilizing computerized client and server systems, often operating over networks such as the Internet. The invention contained hereto teaches a single transaction method of instant automatic payment fulfillment, in which a payment for a single item may be automatically split and forwarded to multiple pre-assigned co-owners of that item. The invention is particularly useful for rapidly transmitting royalties and commissions for point of sale goods or services.

2. Description of Related Art

Computerized Internet electronic commerce (ecommerce) systems have become widespread in the modern world. Such systems, such as PayPal, Amazon.com, and the like enable human users, normally using a local computerized device such as a personal computer, computerized tablet, or cell phone, to select one or more items to purchase from a graphical user interface provided by the local computerized device. The graphical interface will often be provided by a web browser running on the local computerized device. This web server will often be controlled by HTML code downloaded from a remote server. The selection of the item will be detected by various means, such as a mouse click, button push, or pressure sensitive display, and the information that the user desires to make a purchase normally processed by software code residing on the computerized device. This information will then be encoded and transmitted, usually over a network such as the Internet, to one or more remote server devices.

These server devices are normally computerized devices themselves, usually consisting of at least one computer processor, memory devices, network interfaced and the like, as well as associated software such as an operating system (e.g. AIX, Unix, Linux, Windows, and the like), as well as web server software (e.g. Apache, Windows Server software), database and/or database management system (DBMS) software (e.g. MySQL, Oracle, MicroSoft Database software and the like) and associated “glue” software and middleware (e.g. PHP, ColdFusion, and the like).

In a typical ecommerce system, a user will select one or more items to purchase, the information will be relayed to the remote server, and the server will usually record the fact that the item has been purchased in its associated database using appropriate database management and middleware software.

Examples of such prior ecommerce art include Yoshioka (U.S. Pat. No. 5,584,280) who described a content proceeds distribution system, where upon payment of proceeds, shares of a payment are distributed according to ID's stored in a content database. Other examples include Bezos (U.S. Pat. Nos. 6,029,141 and 7,356,507) which described automated systems to do business with large number of associates with minimal supervision, and

### BRIEF SUMMARY OF THE INVENTION

With the rapid growth ecommerce and digital distribution, a new system is needed to help merchants attract more business with content owners to sell goods and services using a royalty payment method that divides financial sums at the point of sale of a transaction based on pre-arranged amounts. The Internet provides a wide array of selling locations for goods and services such as social community websites, web logs, e-mail contacts, and message boards. With the availability of this method, merchants can open unlimited possibilities of distribution with eager content owners and partners on the Internet around the world. Due to the fast pace of instant access of Internet communications, potential partners interested in licensing content and services to the world's markets are in need of an instantaneous method of compensation to ensure trust and a willingness to do business with such ventures.

Unfortunately, although prior art methods enable users to rapidly purchase items over the Internet, and allow for the purchase credit to be rapidly stored for a merchant in the merchant database, the process of then allocating the purchase money to the various companies and individuals who may have produced the item or service to be purchased are cumbersome. For example, consider a song that was produced by a collaborative effort of four independent artists, each of which agreed to an even 25% split of the proceeds, and which is being distributed through a “iTunes” like song distribution service (merchant), here assumed to not be charging a distribution fee. Using current methods, a user purchasing the song for $4.00 would transfer money to the merchant. The merchant would then hold on to the money for a period of time, often 30 days or longer, and then distribute the proceeds to the various artists, often using accounting methods that may not be totally transparent to either the purchaser or the individual artists.

This present state of affairs is highly unsatisfactory, inefficient, prone to potential corruption, and inhibits commerce. The present invention overcomes this unsatisfactory state of affairs by use of an alternative payment system that automatically, and in a transparent manner, distributes the proceeds of an item directly to the individuals and companies that contributed to the item when the purchaser makes the initial purchase. Thus, for example, rather than have to wait for 30 or more days after the buyer's initial purchase of the song, and having to rely upon the honesty and efficiency of the merchant, the various artists would receive credit for their contribution immediately after the purchase. That is, ideally within seconds after the buyer purchases a $4.00 song, each of the four artists will receive credit for $1.00 in his escrow or bank account.

This general method may be used for essentially any service or item, and may also be used to immediately divide up royalties, service fees, raw material expenses, component costs, or essentially any agreed upon financial division for an item or service. By promoting transparency and speed, the invention should have a significant beneficial effect on many areas of commerce. For example, although the “song” example is useful because of its simplicity, the method should also extend to extremely complex financial transactions including complex devices with parts from a large number of vendors and multiple royalties and service fees.

The invention describes an improvement on prior art ecommerce methods that enable such open and instant distribution of proceeds from a single purchase.

In one embodiment, the invention is a method for splitting and distributing payment of at least one item to the accounts of multiple recipients, using a network connected computerized user device, and a network connected ecommerce server. The method will usually consist of constructing at least one table of recipients of the proceeds of a payment for said at least one item, where this one table has at least a list of recipients for the proceeds of the payment for at least one item, and a splitting scheme to distribute the proceeds from the payment of the at least one item to the recipients. The method will usually transmit a payment request for the at least one item across a network from the network computerized user device to a networked connected ecommerce server. The transaction will normally proceed by receiving a payment request for the at least one item at the network connected ecommerce server; and automatically distributing the proceeds from the payment request to the recipients according to said table.

More specifically, the invention will often consist of a method for splitting and distributing payment of at least one item to the accounts of multiple recipients, using an Internet connected computerized user device, and an Internet connected ecommerce server. Here the method will proceed by constructing at least one table of recipients of the proceeds of a payment for the at least one item, where this at least one table will have at least a list of recipients for the proceeds of the payment for the at least one item, and also a splitting scheme to distribute the proceeds from the payment of the at least one item to the recipients. In this version, the method will transmitting a payment request for said at least one item across the Internet from the Internet computerized user device to an Internet connected ecommerce server. The method then involves receiving the payment request for the at least one item at the Internet connected ecommerce server; and automatically distributing the proceeds from said payment request to said recipients according to said table. To do this, the ecommerce server will typically receive payment instructions over said Internet using an ecommerce Applications Programming Interface (API) with an ecommerce API protocol, and the Internet connected computerized device sends said payment request to said ecommerce server following said API protocol. In order for this to work, it will be necessary to first construct or alter the ecommerce Applications Programming Interface (API) protocol to make the API capable of recognizing and following payment instructions according to this at least one table. Once this is done, the method then transmits this at least one table from the Internet connected computerized user device to the ecommerce server along with the payment request. In a common embodiment, the Internet computerized user device will runs web browser software, and the Internet computerized user device will transmit the payment request(s) to the Internet connected ecommerce server using payment software running in the web browser.

In some specific examples shown here, the table is embedded in a JavaScript code that is in turn embedded in an HTML web page that is uploaded from a third Internet connected merchant website to the Internet connected user device prior to the payment. Here the web browser software of the Internet computerized user device will often render this table in a Graphical User Interface (GUI) of the web browser in a form that hides the table, and that allows the user to initiate the payment by triggering a graphical element on a web page rendered by the web browser.

### BRIEF DESCRIPTION OF THE SEVERAL VIEWS OF THE DRAWINGS

FIG. 1 shows a flow chart giving an overview of the process of payment execution by a buyer to an Internet payment service for a product or service. Here the Internet payment service processes the payment by the buyer for delivery to multiple recipients' simultaneously.

FIG. 1A contrasts the JavaScript code of a prior art “Buy Now” button with the JavaScript code of a split payment “Buy Now” button.

FIG. 2 shows a more detailed view of the computerized system graphical user interface, processor, and memory storage used by the invention.

FIG. 2A shows an alternative embodiment of FIG. 2.

FIG. 2B shows another alternative embodiment of FIG. 2.

FIG. 3 shows a more detailed view showing an overview of the software code used to implement the invention.

FIG. 3A shows an embodiment in which the scripting application queries a database and builds a GUI response.

FIG. 3B shows another alternative embodiment of FIG. 3.

FIG. 4 shows a more detailed view of how a single transaction may distribute various payments to multiple recipients.

FIG. 4A shows an alternative embodiment of FIG. 4.

FIG. 4B shows another alternative embodiment of FIG. 4.

FIG. 4C shows still another alternative embodiment of FIG. 4.

### DETAILED DESCRIPTION OF THE INVENTION

With the growing reliance of Internet enabled financial services, merchants are required as a standard business practice to provide a way to accommodate their customers with the convenience of Internet enabled retail systems for selling physical and digital goods. When merchants sell products or operate a business with multiple owners, royalty payments due are not received by the co-owners until the managing member of the venture transmits the payments.

With a traditional royalty payment model, a co-owner is usually paid bimonthly or yearly based on a business agreement. Working with traditional royalty payment models requires additional manual management resources such as lawyers and accountants to audit the financial activity of a partnership.

The Internet based ecommerce payment systems available today allow instant delivery of funds between internal accounts and interaction with brick and mortar banking institutions using the previously described client and server computerized systems, a network (such as an Internet), and software such as an application programmable interface (API). Often the ecommerce systems are accessed through this API, which allows remote computerized systems to access the ecommerce payment systems, and direct the ecommerce systems to perform certain desired financial transaction functions.

An application programming interface (API) is a set of routines, data structures, object classes, and/or protocols provided by libraries and/or operating system services in order to support the building of applications. An API may be language-dependent: that is, available only in a particular programming language, using the particular syntax and elements of the programming language to make the API convenient to use in this particular context. Alternatively an API may be language-independent: that is, written in a way that means it can be called from several programming languages (typically an assembly/C-level interface). This is a desired feature for a service-style API that is not bound to a particular process or system and is available as a remote procedure call.

A more detailed description of API that can be used for ecommerce applications can be found in the book, “Pro PayPal E-Commerce”, by Damon Williams, Apress publishers (2008). Other ecommerce API are also discussed in the book, “Professional Web APIs with PHP: eBay, Google, Paypal, Amazon, FedEx plus Web Feeds”, by Paul Reinheimer, Wrox publishers (2006).

These ecommerce API are often called by programs, scripts, or sections of code residing on user computerized devices. For example, a web browser running on a user computer, cell phone, or other device can download a section of JavaScript or other code from a web server, and then use this code to in turn interact with the API of a remote Internet ecommerce server system and pay for items and services as desired.

Although ecommerce API can be manipulated by many other types of code running on many different types of machine, in order to keep the examples as simple and easy to understand as possible, in this disclosure, use of the familiar web browser/JavaScript API calling software in conjunction with the well known PayPal ecommerce API will generally be favored.

Today's Internet payment services can receive payments from a customer and relay the purchase value to an escrow account for monetary export to a bank account. If the merchant has pre-arranged partnerships and co-owners, the merchant can use manual methods of royalty payment such as paper check payroll mailings or upload a database file to an electronic checking payroll system such as PayPal or MassPay. However none of the current ecommerce services allow all partners of a product or service to get paid in an equal timeframe as real-time point-of-sale transactions take place.

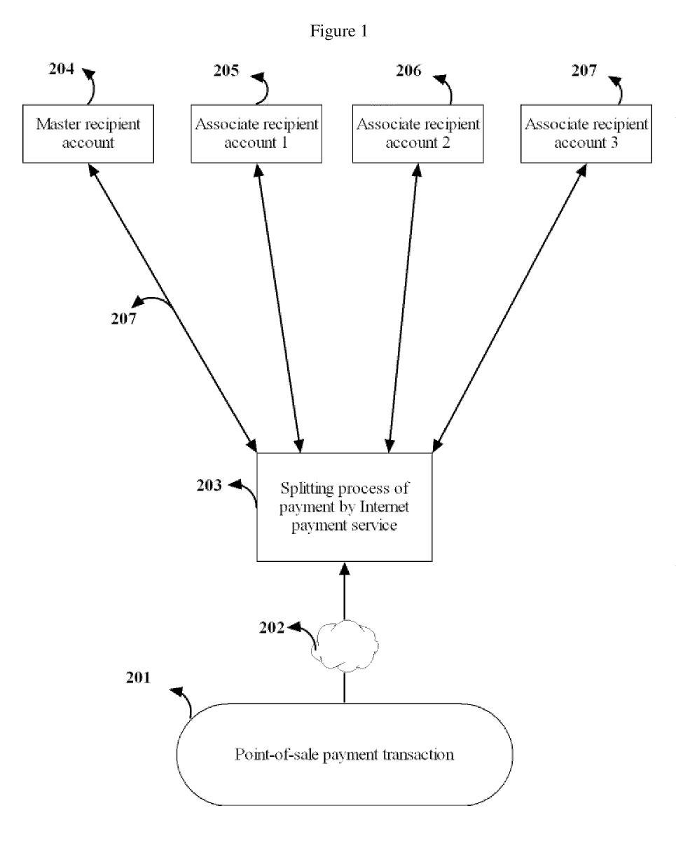

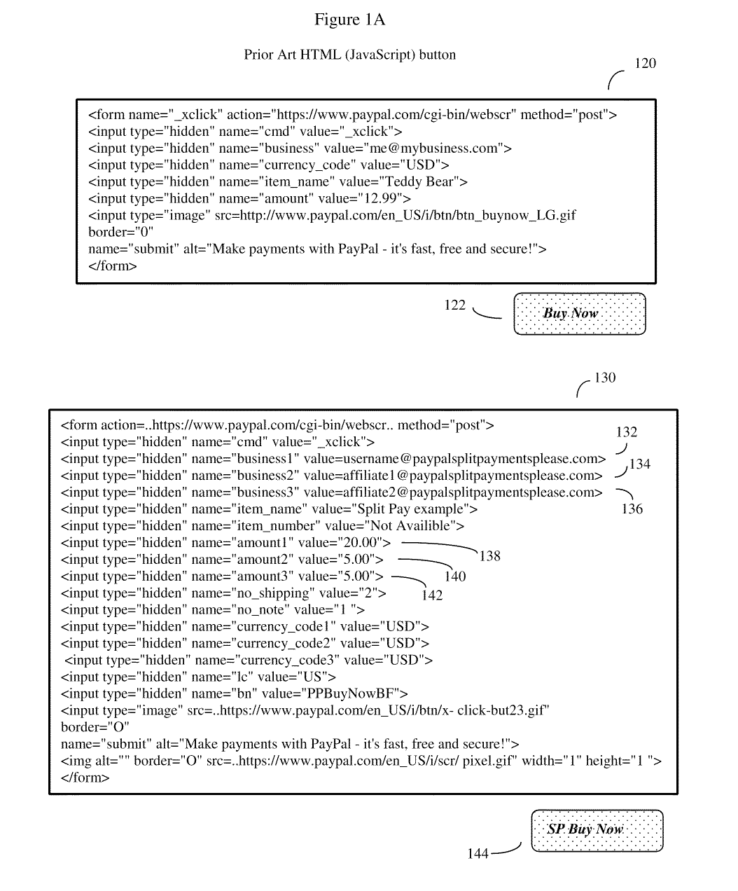

An overview showing one aspect of invention is shown in FIG. 1.

FIG. 1 shows a flow chart representing the process of dividing a payment made by a buyer to multiple recipients through an Internet payment service. Here FIG. 1 (201) represents the act of a buyer making a purchase of an item (in this example, just a single item) using a computerized device that is connected to a network or Internet payment service.

Often the computerized device will be running a web browser or equivalent software. Typically such user computerized devices will consist of at least one computer processor (often chosen from the ARM, x86, Power PC, Cell, or other processor family), memory (e.g. RAM), persistent storage memory (e.g. ROM, flash or hard drive), a display screen, and a pointing device or user input device. The web browser will often be web browser software, such as the commonly used Firefox, Opera, Safari, Microsoft IE, or other web browser software, often running on top of an operating system such as Windows, Linux, or other operating system.

FIG. 1 (202) represents the Internet link between the buyer's computerized device and the remote ecommerce server that is managing the payment service. FIG. 1 (203) represents the computerized Internet payment service (often a system composed of web servers and associated database management hardware and software) used in this system to accept payments from buyers and deliver divided payments of the funds collected simultaneously to multiple recipients according to agreed amounts. Often the Internet payment service will be managed, at least in part, by a master recipient account holder (204) who also acts as the administrator to approve and deny request for recipient additions to code generated by the Internet payment service or API connected application.

According to the invention, the split payments will then be directed to various recipients. These various recipients include individuals, groups, or firms that hold accounts (205), (206), and (207).

In this disclosure, the phrase “The Service” will occasionally be used to represent an Internet based ecommerce service with an application programmable interface (API) accepting controlled computer languages. As another alternative, and for simplicity of interpretation, the term “PayPal” will also be used as a specific example of an Internet based ecommerce system that could potentially use and be enhanced by the invention. However use of the PayPal example should be understood only as an attempt to simply explain the invention.

In fact, the methods of the present invention can be used to divide a single payment made during a point-of-sale transaction to multiple co-owners (herein referred to as “recipients”) for many different types of Internet payment systems. Examples of such Internet payment services such as PayPal, Google Checkout, E-gold, and 2Checkout and many others. The scenarios available to demonstrate the use and execution of this system are very diverse, so this document will explain a common situation and how this method processes split payments.

In a first embodiment and example, a music band with several members signs up with The Service with each member creating an account and adding their financial information and completing all the verification requirements necessary. One member of the group is made responsible for administering the creation and management of the multiple payment division of the collective sum generated by The Service. To define the administrative recipient this document will use the phrase “The Master Recipient”. The Master Recipient creates a new product in The Service to accommodate payment split (i.e. distribution of the payment proceeds) amongst multiple recipients. The Service generates an API readable code that comprises information about multiple payment recipients including account numbers, payment amounts, currencies, discounts, and miscellaneous notes. This information is called a “table”. The Master Recipient adds detailed payment information due to each co-owner during the creation of the readable code used by an ecommerce application programmable interface to parse payment information needed to facilitate the product or service for sale to the customer through a payment gateway used to intake money. This payment information is called a payment “scheme” or “splitting scheme”, and can be a function or lookup table, as well as a percentage or fixed amount.

The Service generates the final code necessary for the band to use on the Internet for such locations comprising of websites, web logs, social networking sites, E-mails, and message boards.

As one example, the music band may wish to set up a web site that makes a music album available for its fans, and use the present invention, in conjunction with an outside and trusted ecommerce service, to ensure that when a fan purchases the album (often by pressing a web browser “purchase” button), a trusted ecommerce system will charge the user's credit card, and then immediately split the proceeds from the sale with the various band members according to a predetermined plan.

Present ecommerce API do not allow this to be done. For example, consider how present ecommerce API interact with web browser based “buy it” (purchase) buttons. This will be shown in the “prior art” example below:

Contrast with Prior Art:

At present, users wishing to send payments for an item to a single recipient may do so by embedding ecommerce code segments into the page code that will be downloaded from an Internet web server to a user's web browser. This code (often JavaScript) will interact with an ecommerce system via the ecommerce API, but there is no ability to split payments for a single purchase.

An example of such a prior art ecommerce code segment, or API readable code structure, used to execute Internet payments is PayPal's “Buy Now” HTML buttons, is shown in FIG. 1A (120). Note that the JavaScript, which is interacting with the PayPal ecommerce API, can only send instructions to purchase or not purchase a product, and it only allows payment to a single user.

This JavaScript is normally hidden from the user, of course, and the user simply triggers the JavaScript code segment to in turn interact with the ecommerce API (here a PayPal API) by pressing a “Buy Now” button. An example of what this “Buy Now” button looks like, when rendered in the GUI of a typical user's web browser, is shown in FIG. 1A (122).

By contrast, in one embodiment of the invention, a more sophisticated ecommerce API is designed to accommodate split payments. This more sophisticated ecommerce API (not shown) may be activated by a more sophisticated JavaScript code segment running on the user's web browser or other device.

In this example of the more sophisticated ecommerce method and system of the invention, the JavaScript running on the user's web browser (normally hidden from the user), which instructs the split payment ecommerce API on the ecommerce server, is shown in FIG. 1A (130). It may be necessary to modify or extend the API of the ecommerce server in order to understand this split payment request, and process it.

In this example, the payment for a single $30 (US dollars) transaction is split among three different recipients, here designated, “business 1”, “business 2”, and “business 3”. These are shown as FIG. 1A as (132), (134), and (136).

“business 1” has a payment escrow account at email address “username@paypalsplitpaymentsplease.com”,
“business 2” has a payment escrow account at email address “affiliate1@paypalsplitpaymentsplease.com”, and
“business 3” has a payment escrow account at email address “affiliate2@paypalsplitpaymentsplease.com”.

The JavaScript code segment of this embodiment of the invention has been instructed to tell the ecommerce API of the remote ecommerce web server to divide the payment for the single $30 item as follows: $20 will be sent to “business 1”, $5 will be sent to “business 2”, and $5 will be sent to “business 3”. This is shown in FIG. 1A (138), (140), and (142).

The JavaScript code, which again may be running on the user's web browser, is often not visible to the user. Thus in this example, it is not because it is set to a “hidden” mode. The code runs the instructions, first on the user's computerized device, and then will send messages out over the Internet to the API of the ecommerce web server, instructing the ecommerce web server to perform the desired fee splits, and credit the escrow accounts of the various users with the fees. Thus in this embodiment, the user simply sees another “Buy Now” button (144), here labeled a “SP Buy Now” button to indicate that this button can implement split payments.

Note that in order for the split payment scheme of the invention to work, a table or array must be generated that will consist of at least the various recipients of the various split payments, and information that allows the system to allocate the split payments. This split payment information can consist of a percentage distribution scheme, a fixed amount payment scheme, or even a series of equations, functions, or payment lookup tables that will allow an automated system to compute the payment amounts.

The split payment table may optionally also have other elements, such as physical or Internet addresses of the various recipients, tax information, withholding information, alternative contact information, telephone numbers, emails, and so on.

Using this PayPal API example for the JavaScript code running on the user's web browser, multiple recipients and their payment allocation are added in advance to payments made by a customer and processing by the PayPal service.

It should be clear that this type of split payment method can be used to handle many different types of split payments. In principle, the JavaScript or other code can be modified to include the possibility of an unlimited amount of co-owners to receive real-time payments from the point-of-sale process. As shown in the JavaScript code example, adding a new entry to each field using an upwards sequence of the number count can progressively add more recipients to divide a sum, in this example this is represented by the values “business2”, “business3”, “amount2”, “amount3”, “currency_code2”, and “currency_code3”. When The Service processes this code during a point-of-sale, the buyer is presented with a single payment with The Service dividing and distributing the sum due to each recipient with instant automation relieving The Master Recipient from manual royalty accounting. With this method in operation, each co-owner receives their share of an expected royalty amount at the same time after a point-of-sale transaction occurs.

Note that in the above example, the details of the various financial splits were first uploaded from a remote web server, such as the band (or a merchant's) web server, to the to the user's computer. The JavaScript then ran on the user's web browser, and then sent messages back to the API of a trusted ecommerce web server informing the trusted ecommerce web server to implement the split payment. Thus in this example, there were at least three Internet nodes involved: the merchant's web server, the user's web browser, and the ecommerce Internet API server, which will often be a web server.

In this example, for ease of understanding, the details of the split payments were shown in easy to read, non-encoded form of JavaScript. This embodiment of the invention is particularly useful for organizations and associations that do not mind exposing the details of their fee split arrangement to outside users. If greater security or privacy is desired, in other embodiments of the invention, the merchant website may upload JavaScript or other code in a form that has been encrypted to shield these details from prying eyes.

In yet another embodiment of the invention, the fee splitting details need not be uploaded from the remote merchant web server to the user's computer at all. Rather, the fee split details may instead be transferred from the merchant web server to the ecommerce web server, and kept hidden from the user (purchaser) and the user's system. In this embodiment, the API of the ecommerce server will be modified to look at the fee split information obtained from the merchant web server, and automatically perform the fee splitting arrangement in a way that totally shields the fee split information from the purchaser.

Alternatively, and in yet another embodiment, instead of opting for greater security and secrecy, the merchant may opt for further openness and transparency, and even allow the user (purchaser) to make decisions on how the fees should be spit up. In this alternative embodiment, the details of the uploaded fee spit information from the JavaScript or other code executing on a users web browser (or other hardware/software combination) will not be hidden, but rather be shown, ideally in the form of an easy to view and manipulate web interface. Thus, for example, music downloaders might be allowed to allocate fee spitting arrangements among favorite band members.

Although a specific example using a small number of split payment recipients, and operating using a specific type of web browser executable JavaScript code interacting with a specific remote payment API (here the PayPal API), has been given, it should be evident that these principles can be extended to a broad array of different hardware and software systems.

Here, a broader number of alternative invention embodiments, as well as alternative definitions and methods, will be discussed.

### Further Discussion:

As previously discussed, in this invention, payment processing handling may be defined and implemented in a text based computer language (also known as “code”) formatted for interpretation by an application programmable interface (API) as part of an Internet payment service.

An API may be language-dependent; that is, available only in a given programming language, using the syntax and elements of that language to make the API convenient to use in this context, or alternatively language-independent; that is, written in a way that means it can be called from several programming languages (typically an assembly or C interface). This is a desired feature for a service-style API that is not bound to a given process or system and is available as a remote procedure call.

Within the server, the API may have multiple communication connection points for call and response actions for interpretation when presented with the compatible formatted code. Examples of API communication connection points for data transmission includes, but is not limited to Automated programmable action scripts, a Graphic User Interface (GUI) for human information input and response handling, a database to store and retrieve operations data, a monitor provision to send periodical or real-time operations data to a webmaster, and cron (a time based job scheduler in a Unix-like computer operating system) jobs scheduled to perform maintenance and service upgrades to the underlying API code.

The compilation of multiple payment recipient account credentials for preparation of formatting the code for transmission and processing by the API server when engaged by a human administrative user is facilitated through a GUI.

The GUI is often a visual interface that is programmed for human understanding and interaction using programming languages including but not limited to HTML, PHP, Perl, Ajax, Java, C, C++, C#, J#, ASP.Net, Visual Basic, Ruby on Rails, Flash, Actionscript, Applescript, and JavaScript. The GUI is comprised of presentation ready programming code running on a host operating system including but not limited to Microsoft Windows, Apple Mac OS, Linux, Symbian, Java, Windows CE, Windows Mobile OS, iPhone OS, Android, Chrome OS, and web browsers. Local devices hosting the operating system used to present the GUI to the human user included but not limited to a Desktop Computer, Laptop Computer, Netbook Computer, Nettop Computer, Tablet Computer, Mobile Phone, PDA, Kiosk, Point-of-Sale Terminal Computer, and an Integrated Computer as part of a vehicle or machine of human transport.

The Secondary Code is a representation of the formatted code (for the API server) linked for access through a database. Secondary Code is a shortened or more managed code used in GUI presentations to human users. Examples of secondary code used in GUI presentations includes but not limited to JavaScript embedded “Buy Now” graphical click button, hyperlinks, software application action buttons, hardware push buttons, and SMS text numbers as used by mobile devices. This secondary code is first executed by the processor on the user's local device, and in this Secondary Code in turn sends a message to the processor residing on the remote server to execute one or more desired commands or functions.

The remote server of the Internet payment service typically receives a message transmitted by the Secondary Code from the device local to the user, and may in turn send this message to a remote processing server. Often the function will be an action script to query a database linked to the remote device for Secondary Code, find and copy the related Formatted Code, then initiate the action of code transmission to the API server.

The API server may send response calls to the remote processing server with additional user metadata; the processing server queries the remote database for the Formatted Code or metadata reference and sends an action response back over the Internet to the local device to the human user. This response may be mediated by a GUI host application residing on the user's local device, as well as other local devices including Internet connected text transmission devices, webpage, e-mail, SMS text messages, instant message applications, non-GUI software, sound audio prompts, and even automated telephone calls with or without caller-ID.

As previously discussed, the Data Entry GUI facilitates text entry by a user to collect data needed for the preparation of the formatted code used to communicate with the API. The GUI is accessed by action initiating users including but not limited to:

1) The administrative user who as a co-recipient, prepares the code to represent him/her as well as a multiple amount of other co-recipients, collectively as benefactor owners of a percentage or explicit amount of the collective sum presented to the payer as a single transaction.
2) The paying user (the payer) who executes a transaction action of the collective single sum using the GUI provided by the Internet payment service processing the formatted code directly, or interaction with a connected application communicating with the Internet payment service API server.

The administrative user GUI may be comprised of a text entry field for payee recipient account credentials (which is recognized for processing by the Internet payment service), and a price entry field to allocate how much of the collective sum will be split to the payee recipients. The GUI provides an action button or link to add more payee recipients to add for sum division, and calculates the total sum for the administrative user awareness of the total amount to be presented through the application to the payment sender. The administrative user selects an action to save or compile the text entries made in the GUI and the computer server and connected database stores converted formatted code performed by a multi-language translation action script contained on the local or remote computer server. On the GUI, the administrative user is presented with the Formatted Code for use with a computer server (as part of an application) to communicate with the API server, or presented with a Secondary Code representing the stored Formatted Code in the database connected to the API server.

An ecommerce API runs on computer servers comprised of hard drives, central processing units, memory, and networking hardware (usually connected to the Internet) to receive and send data transmissions for interpretation with connected software applications from a web server or desktop program and hardware applications with embedded code storage. Software and hardware applications connecting and communicating data to an API may be contained on a separate unit than the API unit. The term “connected” in this invention refers to a networked communication for multiple way transfer of data including but not limited to Broadband Cable, Fiber Optic, an Intranet, an Internet, WAP, Wireless Broadband, WIFI, White Band Space Internet, Satellite, Power Plug Data, Local Area Networks, Bluetooth, Remote Frequency, Proxy Server, EDGE Network, GPS, GPRS, and Dial-up,

As a software application, the API runs as an executable process on an operating system installed on the computer server connected to a local or remote database to receive and send code instructions from Internet connected applications. API software are made from computer programming languages created by a human programmer and designed to execute pre-defined instructions in cooperation with a software language specific code interpreter. An interpreter may be a program that either
1. Executes the source code directly
2. Translates source code into some efficient intermediate representation (code) and immediately executes this
3. Explicitly executes stored precompiled code made by a compiler which is part of the interpreter system.

API software are written with programming languages including but not limited to HTML, PHP, Ruby on Rails, Java, C, C++, C#, ASP.Net, Visual Basic, J#, Cocoa. Perl, Pascal, JavaScript, and Cobra. Example operating systems used to host an API process are, but not limited to, Microsoft Windows, Apple Mac OS X, open and closed source Linux, UNIX and Chrome OS.

A database is an integrated collection of logically related records or files which consolidates records into a common pool of data records that provides data for the API. The database collects information sent from the connected applications then organized on the servers hard drive storage so that it can easily be accessed, managed, and updated. An example of database types includes but not limited to Operational, Analytical, Data Warehouse, Distributed, End-User, External, Hypermedia, In-Memory, Document-oriented, and Real-time. Database model, also known as a schema is the structure or format as describe by the format language as recognized in a database management system. Example of database models includes but not limited to Flat-file, Hierarchical, Network, Relational, Dimensional, and Object. Example database management systems include but not limited to MySQL, SQL, Oracle, DB2, MS Access, MS SQL, PostgreSQL, and Apache Derby.

As a hardware application, the API operational code and interpreter may be hard-coded to updatable embedded or removable flash memory or static silicon chips as part of a data communications and network connectable circuit motherboard system. Examples of data communications and network connectable circuit motherboard systems includes but not limited to Mobile phones, PDA, Tablet PC, Netbook, Laptops, Navigation device, Barcode scanner, Fingerprint reader, Credit card terminals and other wired and wireless payment acceptance devices.

Recipient accounts used in this invention may be hosted with a membership to an Internet payment service that operate direct and remote (through the API) financial tasks comprising of multiple currencies to be received, sent and stored in escrow from credit cards, other membership accounts, and bank account drafts. Each recipient added to the computer code configured for the API server must have an established membership account with the Internet payment service providing the code interpreting API server. When multiple sums are divided from the purchase sum paid by the payer, the API server updates the database record for each membership account represented in the Formatted Code to add the pre-set sum due in mathematical addition to the previous account balance on record. The recipients of the payment division will manually or automatically transfer funds to an identified bank account on record for association with the membership account, or access proceeds resulting from the automated method process of this invention as they become available with a debit card issued and managed by the Internet payment service.

In another embodiment and example, a payer may engage with a product or service for purchase that is usually presented by a webpage as part of a website through a web browser running on an operating system from a computer or mobile device with a data connection. The payer is further presented with a GUI (graphical user interface) on the local device that displays a price to be paid with a single transaction, which may be facilitated with an Internet payment service such as PayPal, Google Checkout, Amazon Payments, and 2Checkout. The payer executes the willingness to continue the payment action by clicking a button or a link, which may often display phrases such as “Buy Now” or “Pay Now”.

The button or link contains (i.e. is connected to by software) Formatted Code or Secondary Code which, upon action by the payer, is processed by the processor or CPU on the user's local device, and then is transferred (usually over a network such as the Internet) to the processor or CPU of the server and held in a temporary memory using RAM or local or remote disk storage buffer. This transfer over the Internet may be either a direct wire connection or may be a wireless connection, such as over a cell phone connection, or wireless Internet connection.

Using programmable action scripting to automate the process of this invention, the CPU or processor on the server queries a local or remote database for the Formatted Code either directly or by relation according to a Secondary Code for verification of compliance and validity.

Once the server processor or CPU determines that the Formatted Code is within compliance and is valid, the server CPU or processor relays the Formatted Code to the API processor which can either be a software or hardware application running on the same CPU server sending the Formatted Code, or a networked CPU server.

The API processor interprets the Formatted Code as a success or failure. If a failure is encountered, the API processor compiles a data response to relay to the server CPU that prepares a GUI presentation for the payer relaying the failure and optionally, the reason for the error. If success is encountered, the API processor compiles a data response to relay to the server CPU that prepares a GUI presentation for the payer in which a payment can proceed.

### Payment Schemes

The GUI presents the payer with data entry options to input payment credentials which are usually a single or mix source comprising a credit card, a charge card, a debit card, a bank draft, a positive balance of a membership escrow account, or virtual points. Monetary intake and financial division by the Internet payment service is diverse as per the payment method:

1) Credit card, charge card, bank draft, and debit card—the Internet payment service server CPU sends an authorization request to debit funds from the card account holder to the server CPU of the issuing financial institution. The issuing financial institution will usually receive the request and verify that the funds are available. Upon failure of the funds availability verification, the server CPU of the issuing financial institution may compile and send the failure response to the server CPU of the Internet payment service. The Internet payment service server CPU then relays the failure response to the connected GUI presented to the payer.

Upon success of the funds availability verification, the server CPU of the issuing financial institution will often compile and send a success response along with a session identifier or token to the server CPU of the Internet payment service. The issuing financial institution generates the session identifier or token as an electronic promissory note to the bank of the Internet payment service. When the server CPU of the Internet payment service receives the success response from the server CPU of the issuing financial institution, the Internet payment service updates the database record of all membership escrow accounts with the designated divided sums as referenced in the database using relational data to determine action association.

2) Membership escrow account and virtual points—the Internet payment service server CPU may query the local or remote database to determine the balance available in the membership escrow account or virtual points account owned by the payer. If the balance queried does not match or exceed the payment amount, then the server CPU may compile and send a failure response to the connected GUI for payer review and may optionally provide an explanation for the error. If the balance queried does match or exceed the payment amount, then the server CPU may compile and send an action request through the GUI to the payer to agree or disagree to use the account balance to make the payment. When the payer agrees to use the account balance, the total sum is subtracted from the payer's account and processed with the server CPU to divide the sum to multiple sums as defined by the relational transaction data contained on the local or remote database, and sums credited to the membership accounts of the recipients defined in the Formatted Code.

Once the membership accounts of the recipients are credited with the divided sums, the recipients can manage their account balances with the Internet payment service, often by requesting bank transfers of the funds held in escrow, by requesting a physical or electronic check for the account balance, and/or by using an ATM machine to withdraw escrow funds with a debit card issued by the Internet payment service.

### Further Examples

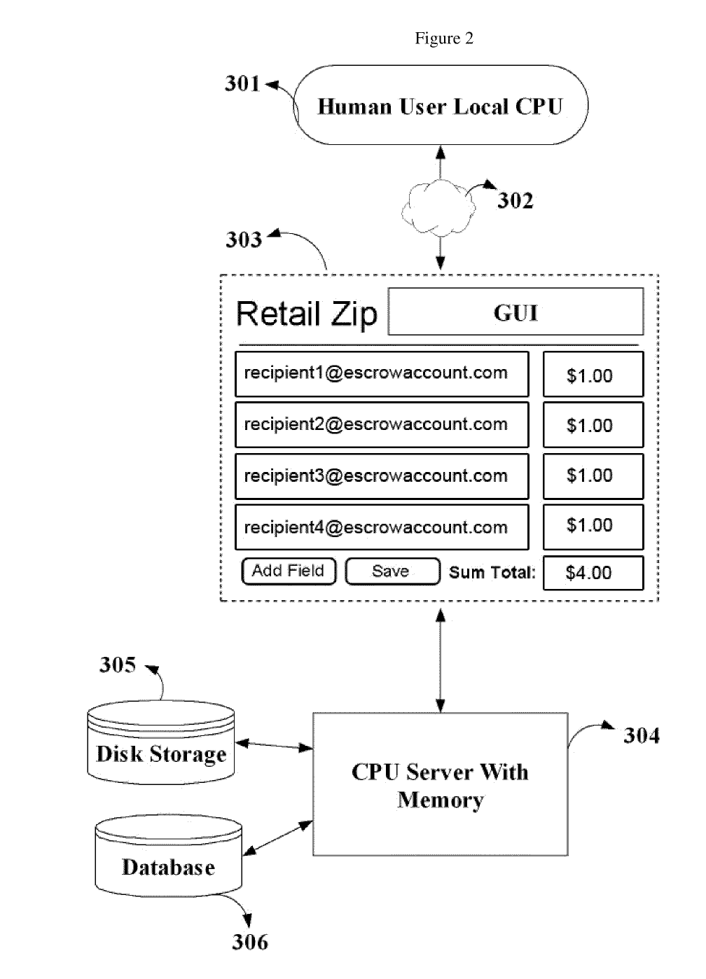

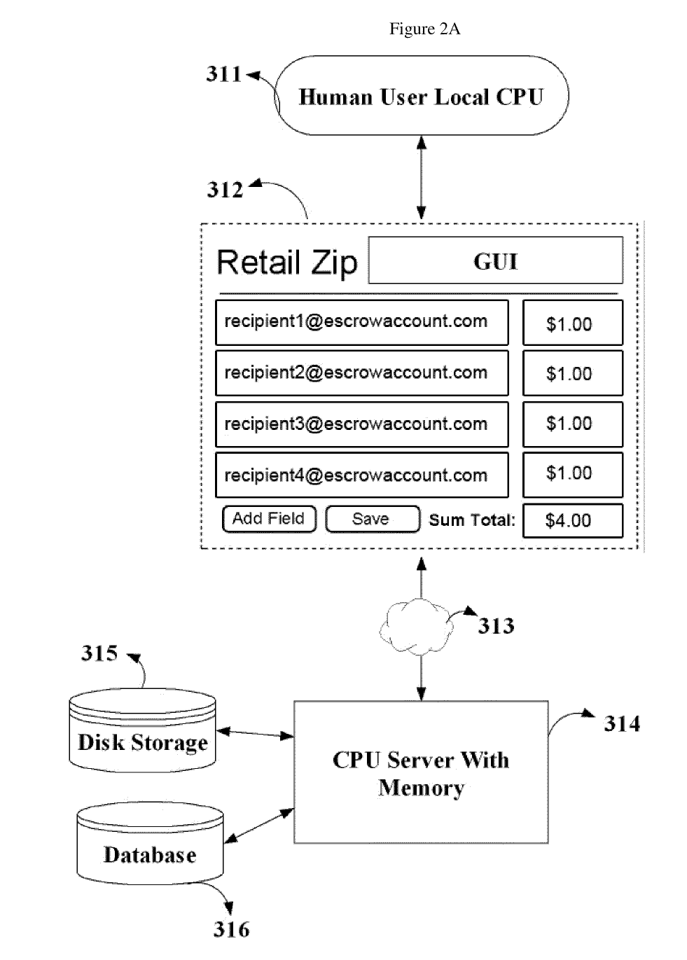

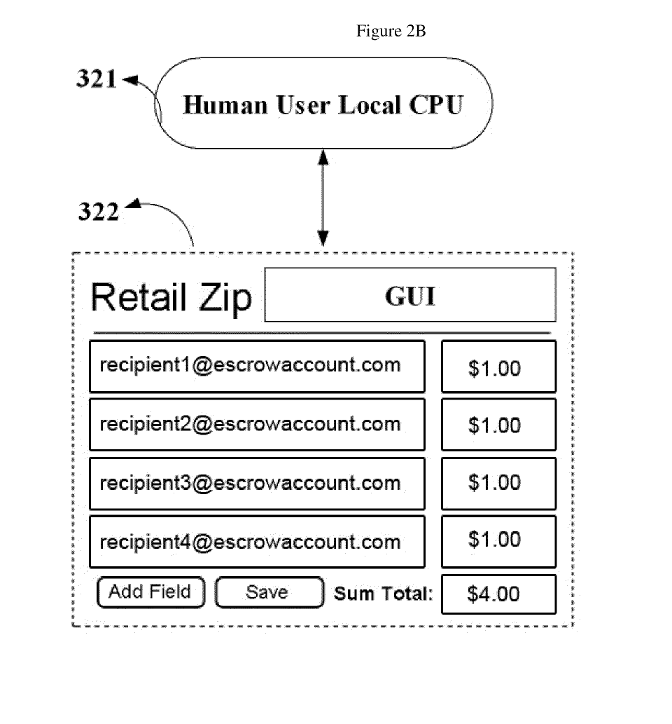

FIG. 2 shows an embodiment in which a human user (301) interacts with the system with an Internet data connection (302) through a graphical user interface (303), which may reside on a computer screen, cell phone screen, or other computerized user interface device. This graphical user interface of FIGS. 2-4 will often be a software window or web browser running interactive software such as JavaScript, PHP, Java, ASP.Net, Ajax, C#, J#, Perl or Ruby on Rails. By using the text entry fields contained within the GUI, the user may define various recipients and diverse sums to be divided from the payment. Alternatively, these various recipients and diverse sums may be pre-computed and either shown to the user, or alternatively hidden from the user.

The GUI displays a calculated total sum representing the compilation of the collective list of recipient accounts and financial amounts. In one embodiment, the user may save the payment configuration with a button on the GUI that transmits the unformatted data for conversion processing to the CPU server (304) running an operating system such as Microsoft Windows, Linux, Apple Mac OS, or Unix. The CPU server converts the unformatted data to Formatted Code and optional Secondary Code using a programmable scripting application stored on the local or remote disk storage (305) of the CPU server. Once the conversion process is complete, the CPU server saves the Formatted Code and Secondary Code (if present) to the local or remote database (306) and calls an action for reply of converted information to the GUI.

FIG. 2A shows an alternate embodiment of FIG. 2 in which a human user (311) interacts with a GUI (312) embedded in a software application hosted on an operating system running the CPU controlled by the human user. The GUI displays a calculated total sum representing the compilation of the collective list of recipient accounts and financial amounts. In one embodiment, the user may save the payment configuration with a button on the GUI that transmits the unformatted data for conversion processing through a data connection (313) (usually an Internet data connection) to the CPU server (314) running an operating system. The CPU server converts the unformatted data to Formatted Code and optional Secondary Code using a programmable scripting application stored on the local or remote disk storage (315) of the CPU server. Once the conversion process is complete, the CPU server saves the Formatted Code and Secondary Code (if present) to the local or remote database (316) and calls an action for reply of converted information to the GUI.

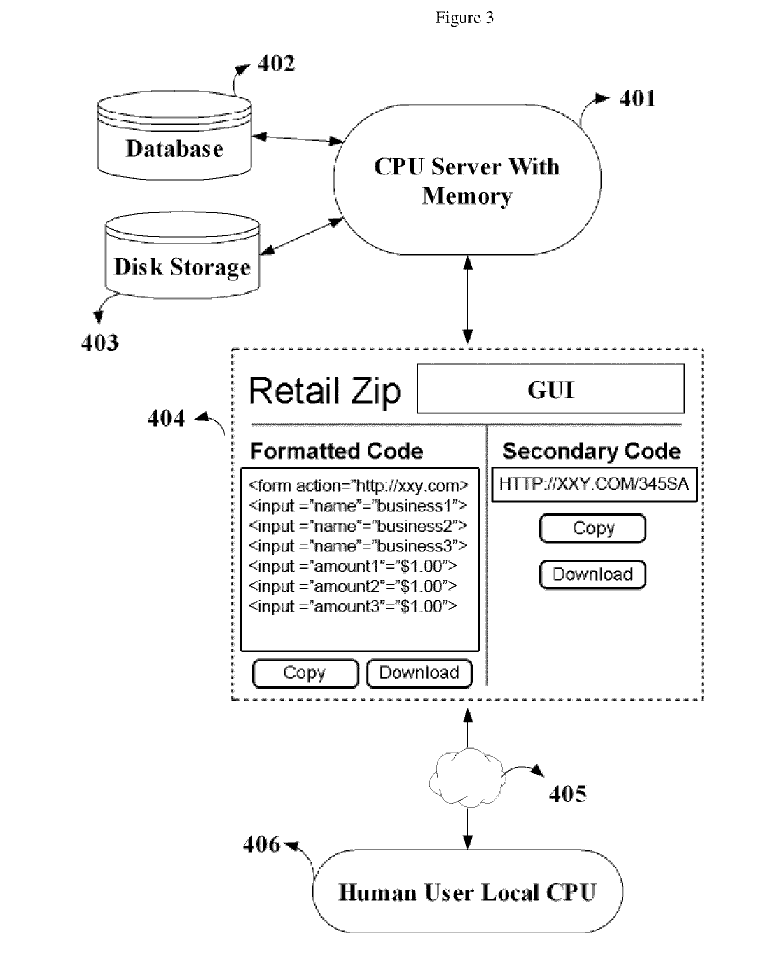

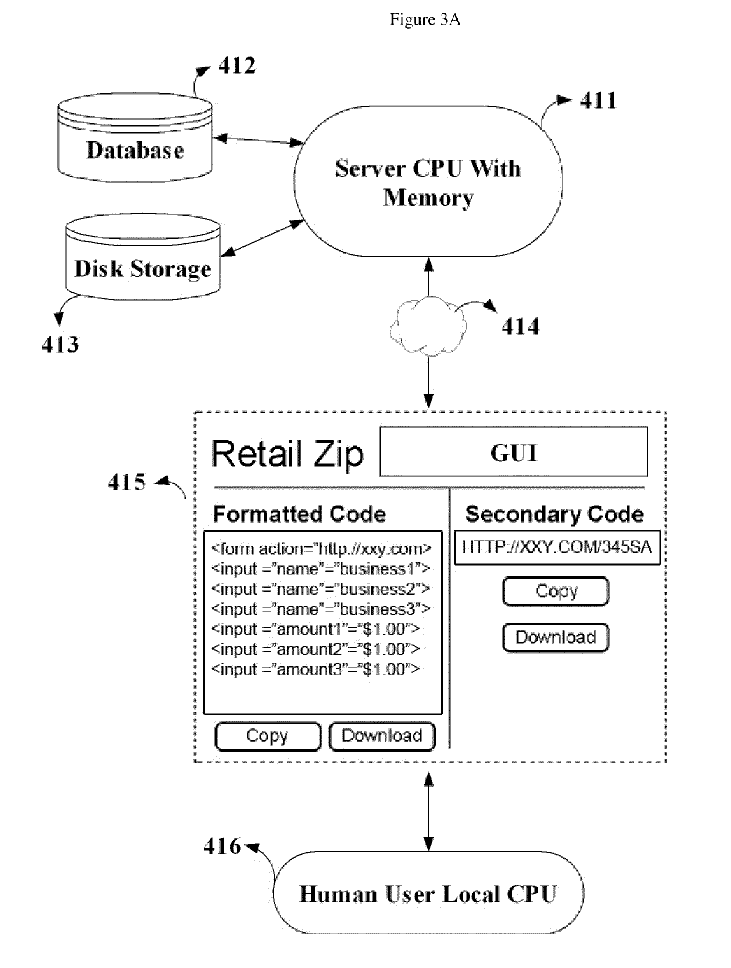

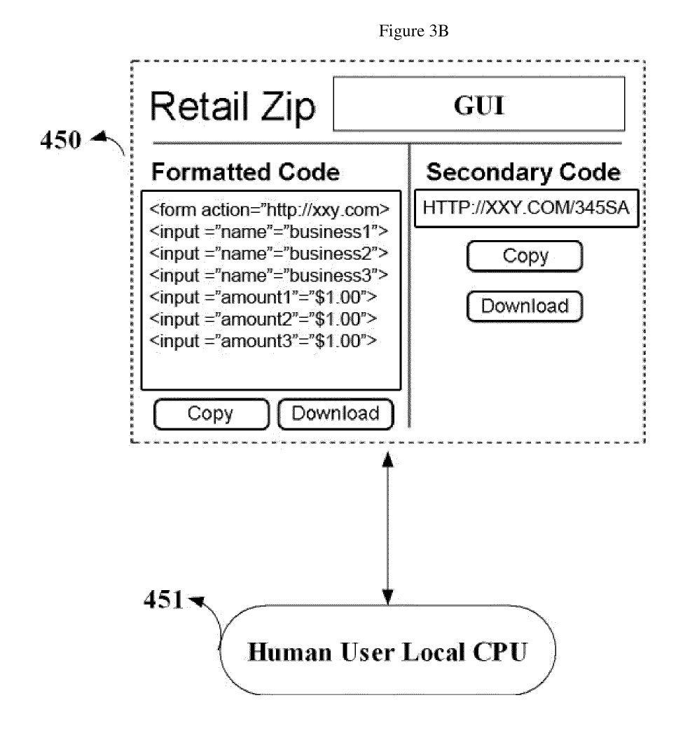

FIG. 2B shows an alternate embodiment of FIG. 2 in which a human user (321) interacts with a GUI (322) embedded in a software application hosted on an operating system running the CPU controlled by the human user. The GUI displays a calculated total sum representing the compilation of the collective list of recipient accounts and financial amounts. The software application offers the user an option to save the payment configuration and converts the unformatted data to Formatted Code and optional Secondary Code using an algorithm (compliant to the API) as part of the software application. Once the conversion process is complete, the software application saves the Formatted Code and optional Secondary Code (if present) to a local temporary file, temporary memory, or a permanent file and calls an action for reply of converted information to the GUI as explained in FIG. 3B.

FIG. 3 shows an embodiment in which the CPU programmable scripting application (401) queries the local or remote database (402) for the converted code and builds a GUI response using the CPU with temporary data needed for processing stored on the local or remote disk storage (403) for transmission through the GUI (404). The GUI displays the Formatted Code and optional Secondary Code transmitted over a data connection (405) (usually an Internet data connection) to the human user (406) with options to copy the code to a temporary memory location on the operating system hosting the viewer (usually a web browser) of the GUI, or download the code to a file for local or remote disk storage of the user.

FIG. 3A shows an alternative embodiment of FIG. 3 in which the CPU programmable scripting application (411) queries the local or remote database (412) for the converted code and builds a GUI response using the CPU with temporary data needed for processing stored on the local or remote disk storage (413) for transmission over a data connection (414) (usually an Internet data connection) to a GUI (415) embedded in a software application hosted on an operating system running the CPU controlled by the human user (416). The GUI displays the Formatted Code and optional Secondary Code to the human user with options to copy the code to a temporary memory location on the operating system hosting the software of the GUI, or download the code to a file for local or remote disk storage of the user.

FIG. 3B shows an alternative embodiment of FIG. 3 in which the GUI (450) as part of a software application hosted on an operating system running the CPU controlled by the human user (451). The GUI returns Formatted Code and optional Secondary Code for view to the user after completing the conversion process of the unformatted data explained in FIG. 2B.

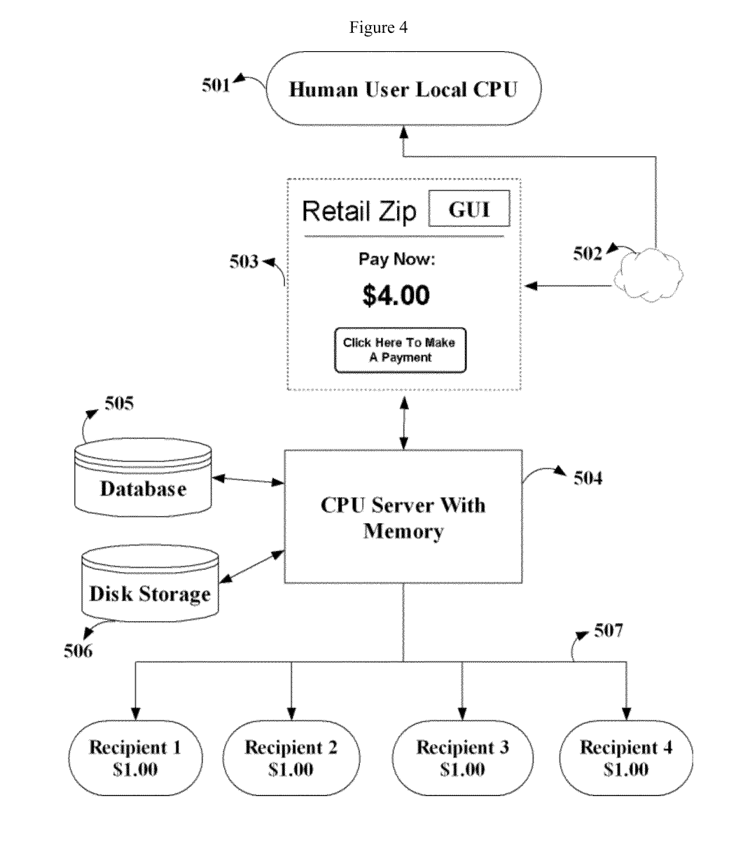

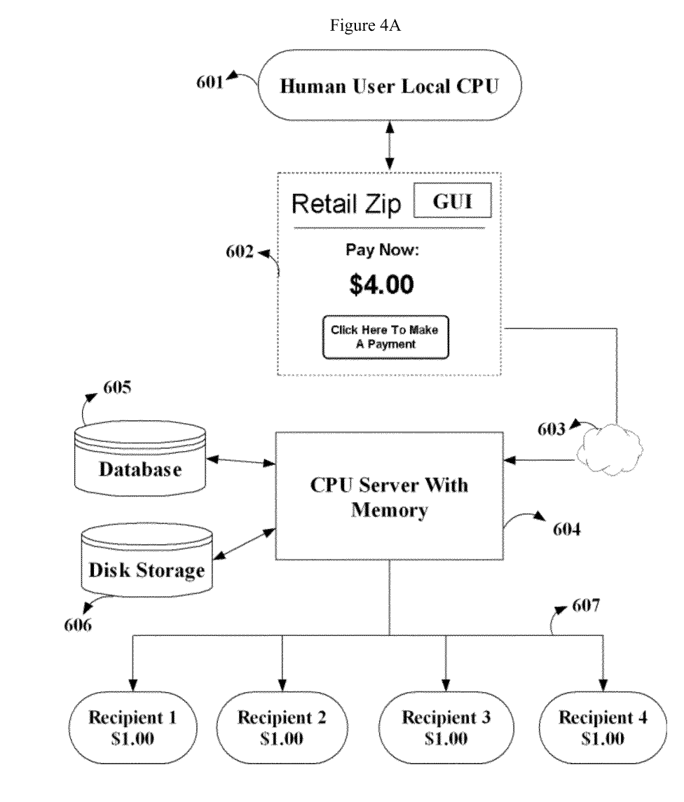

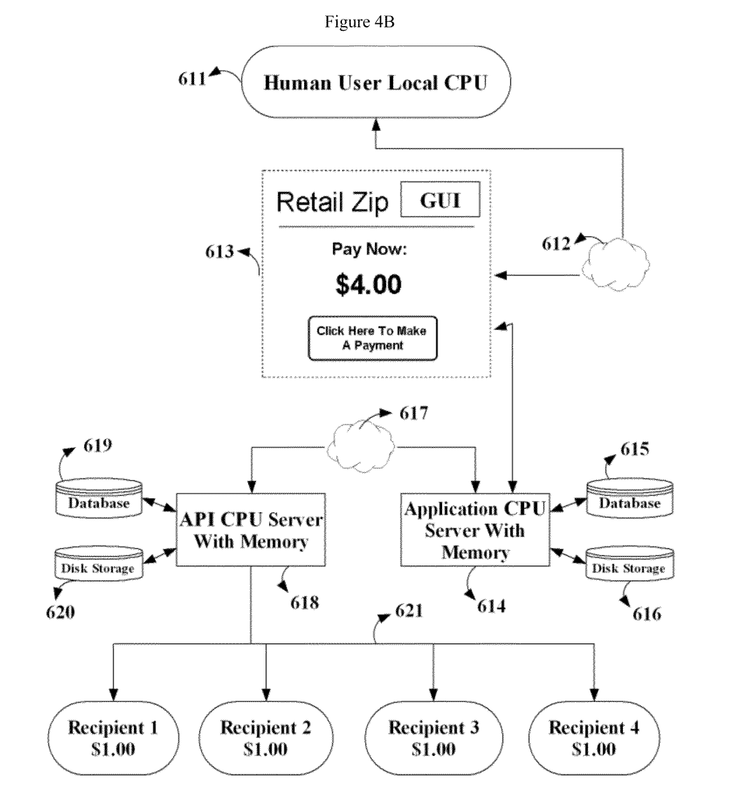

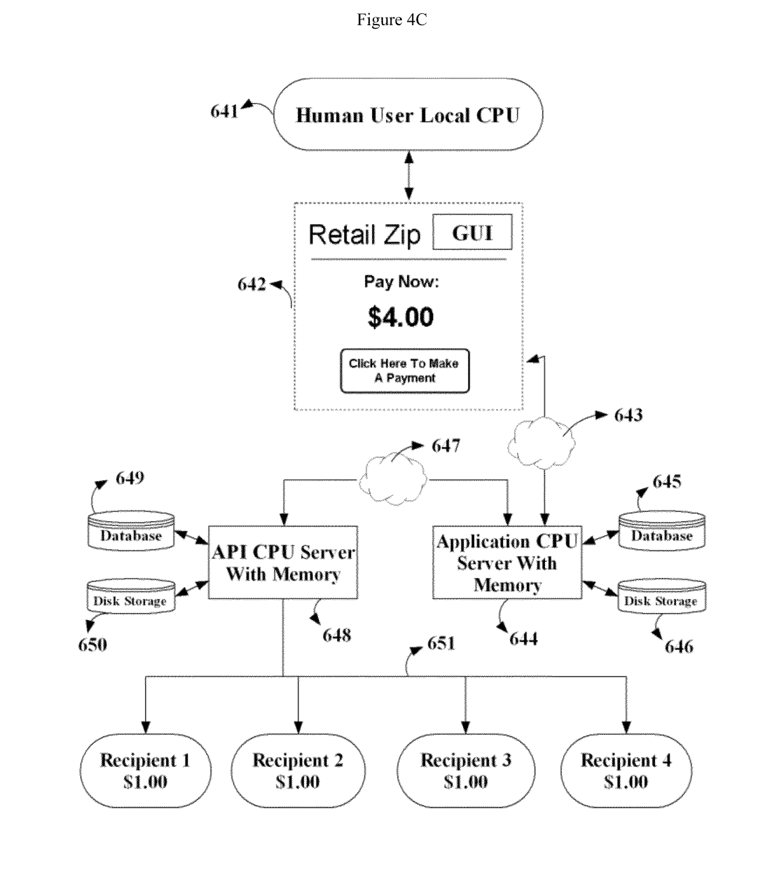

FIG. 4 shows an embodiment in which the human user (501) interacts with the system with a data connection (502) (usually an Internet data connection) through a GUI (503), which may reside on a computer screen, cell phone screen, or other computerized user interface device. The GUI embeds the Formatted Code or Secondary Code and a single price for payment. The GUI contains an embedded action button or link for the user to select. When the user press the button or link, the GUI sends the Formatted Code or Secondary code to the Internet payment service usually through a web browser GUI to the CPU server (504) for processing. If the GUI transmits the Secondary Code, then the CPU will first query the database (505) for reference to the Formatted Code and stores it as a temporary data file on the disk storage (506). The CPU server cross-reference the Formatted Code with the code stored on the local or remote database for verification and compliance. If the CPU server finds a discrepancy with the Formatted Code or Secondary Code served from the GUI, the CPU server will send an error message to the GUI for user review. When the CPU server verifies to the Internet payment service validation and security application to proceed, the Internet payment service receives and process the payment using a local or remote money drafting process involving a single or combination of financial sources such as a membership escrow account balance, credit card, bank draft, gift certificate, or virtual points. When the single payment is made and verified as completed by the Internet payment service payment processing application, the CPU server divides the received sum defined in the Formatted Code to multiple sums sent directly to the membership escrow accounts (507) by updating the database record keeping an account of balances and transactions.

FIG. 4A shows an alternative embodiment of FIG. 4 in which the human user (601) interacts with a GUI (602) as part of a software application hosted on an operating system running the CPU controlled by the human user. The GUI embeds the Formatted Code or Secondary Code and a single price for payment. The GUI contains an embedded action button or link for the user to select. When the user press the button or link, the GUI sends the Formatted Code or Secondary code to the Internet payment service through a data connection (603) (usually an Internet data connection) to the CPU server (604) for processing. If the GUI transmits the Secondary Code, then the CPU will first query the database (605) for reference to the Formatted Code and stores it as a temporary data file on the disk storage (606). The CPU server cross-reference the Formatted Code with the code stored on the local or remote database for verification and compliance. If the CPU server finds a discrepancy with the Formatted Code or Secondary Code served from the GUI, the CPU server will send an error message to the GUI for user review. When the CPU server verifies to the Internet payment service validation and security application to proceed, the Internet payment service receives and process the payment using a local or remote money drafting process involving a single or combination of financial sources such as a membership escrow account balance, credit card, bank draft, gift certificate, or virtual points. When the single payment is made and verified as completed by the Internet payment service payment processing application, the CPU server divides the received sum defined in the Formatted Code to multiple sums sent directly to the membership escrow accounts (607) by updating the database record keeping an account of balances and transactions.

FIG. 4B shows an alternative embodiment of FIG. 4 in which the human user (611) interacts with the system with a data connection (612) (usually an Internet data connection) through a GUI (613) hosted on an Application CPU Server (614) with a data connection (617) (usually an Internet data connection) to an API CPU Server (618) of an Internet payment service. The owner of the Application CPU Server is usually a merchant website using the Internet payment service as a payment option for their customers. The GUI provided by the Application CPU Server may be accessed by the user on a computer screen, cell phone screen, or other computerized user interface device. The Application CPU Server can optionally host automated action scripts written in a programming language such as Javascript, PHP, Perl, Ruby on Rails, ASP.Net, or Java. The Application CPU Server can compile Formatted Code on-the-fly to facilitate a mall style merchant website where multiple sellers with membership escrow accounts with the Internet payment service are selling goods at the same location. By compiling the product selections made by the payer, the Application CPU Server queries the database (615) to retrieve the sum due for each list selection. The Application CPU Server saves temporary data to the disk storage (616) to convert the collected unformatted code into Formatted Code and calculates a single price for payment to the user through the GUI (usually with a GUI button labeled “Click Here To Make A Payment” or “Checkout Now”). When the user press the button or link, the GUI sends the Formatted Code or Secondary code to the API CPU Server of the Internet payment service for processing. The API CPU Server cross-reference the Formatted Code with the code stored on the local or remote database (619) and temporary or permanent data written to the disk storage (620) for verification and compliance. If the API CPU server finds a discrepancy with the Formatted Code, the API CPU Server will usually send an error message to the Application CPU Server with relay to the GUI for user review. When the CPU server verifies to the Internet payment service validation and security application to proceed, the Internet payment service receives and process the payment using a local or remote money drafting process involving a single or combination of financial sources such as a membership escrow account balance, credit card, bank draft, gift certificate, or virtual points. When the single payment is made and verified as completed by the Internet payment service payment processing application, the CPU server divides the received sum defined in the Formatted Code to multiple sums sent directly to the membership escrow accounts (621) by updating the database record keeping an account of balances and transactions.

FIG. 4C shows an alternative embodiment of FIG. 4 in which the human user (641) interacts with a GUI (642) as part of a software application hosted on an operating system running on a CPU in control by the user. The GUI uses a data connection (643) (usually an Internet data connection) to log user activity or regulate transactions on an Application CPU Server (644). The Application CPU Server logs user activity using a database (645) and temporary data disk storage (646) that can optionally be used to manage application upgrades and updates. Using a data connection (647) (usually an Internet data connection) the Application CPU Server pass-through Formatted Code received from the software application (while logging user activity to the database) to the API CPU Server (648) of an Internet payment service. The owner of the Application CPU Server is usually a software developer using the Internet payment service as a payment option for their users. The API CPU Server may log access activity in the database (649) by the Application CPU Server using a developer API key identifier. The API CPU Server may use temporary or permanent data written to the disk storage (650) for verification and compliance of the submitted Formatted Code. If the API CPU server finds a discrepancy with the Formatted Code, the API CPU Server will usually send an error message to the Application CPU Server with relay to the software application GUI for user review. When the API CPU Server verifies to the Internet payment service validation and security application to proceed, the Internet payment service receives and process the payment using a local or remote money drafting process involving a single or combination of financial sources such as a membership escrow account balance, credit card, bank draft, gift certificate, or virtual points. When the single payment is made and verified as completed by the Internet payment service payment processing application, the CPU server divides the received sum defined in the Formatted Code to multiple sums sent directly to the membership escrow accounts (651) by updating the database record keeping an account of balances and transactions.

1. A method for splitting and distributing payment of at least one item to the accounts of multiple recipients, using a network connected computerized user device, and a network connected ecommerce server, comprising:
constructing at least one table of recipients of the proceeds of a payment for said at least one item, said at least one table comprising at least a list of recipients for said proceeds of said payment for at least one item, and a splitting scheme to distribute said proceeds from said payment of said at least one item to said recipients;
transmitting a payment request for said at least one item across said network from said network computerized user device to said networked connected ecommerce server;
receiving said payment request for said at least one item at said network connected ecommerce server; and automatically distributing said proceeds from said payment request to said recipients according to said table.

2. The method of claim 1, in which the said network is the Internet.

3. The method of claim 2, in which said ecommerce server receives payment instructions over the Internet using an ecommerce Applications Programming Interface (API) with an ecommerce API protocol, and said network connected computerized device sends said payment request to said ecommerce server following said API protocol.

4. The method of claim 3, further making said ecommerce Applications Programming Interface (API) protocol capable of recognizing and following payment instructions according to said at least one table, and transmitting said at least one table from said network connected computerized user device to said ecommerce server along with said payment request.

5. The method of claim 3, further making said ecommerce Applications Programming Interface (API) protocol capable of recognizing and following payment instructions according to said at least one table, and transmitting said at least one table from a third merchant network connected server to said ecommerce server along with said payment request.

6. The method of claim 3, further making said ecommerce Applications Programming Interface (API) protocol capable of recognizing and following payment instructions from said at least one table, and transmitting said at least one table to said ecommerce server in advance of said payment request.

7. The method of claim 2, in which the networked computerized user device runs web browser software, and said network computerized user device transmits said payment requests to said network connected ecommerce server using payment software running in said web browser.

8. The method of claim 7, in which said payment software running in said web browser transmits said table to said ecommerce server along with said payment request.

9. A method for splitting and distributing payment of at least one item to the accounts of multiple recipients, using an Internet connected computerized user device, and an Internet connected ecommerce server, comprising:
constructing at least one table of recipients of the proceeds of a payment for said at least one item, said at least one table comprising at least a list of recipients for said proceeds of said payment for at least one item, and a splitting scheme to distribute said proceeds from said payment of said at least one item to said recipients;
transmitting a payment request for said at least one item across said Internet from said Internet computerized user device to said Internet connected ecommerce server;
receiving said payment request for said at least one item at said Internet connected ecommerce server; and automatically distributing said proceeds from said payment request to said recipients according to said table;
in which said ecommerce server receives payment instructions over said Internet using an ecommerce Applications Programming Interface (API) with an ecommerce API protocol, and said Internet connected computerized device sends said payment request to said ecommerce server following said API protocol; and
making said ecommerce Applications Programming Interface (API) protocol capable of recognizing and following payment instructions according to said at least one table.

10. The method of claim 9, in which said accounts of multiple recipients are escrow accounts, and said escrow accounts may accumulate said proceeds received from multiple payments.

11. The method of claim 9, in which said Internet connected computerized device is selected from the group consisting of cellular telephones, personal computers, pocket computers, tablet computers, and telephones.

12. The method of claim 9, in which said Internet computerized user device interacts with the Internet through software selected from the group consisting of web browser software, email software, and telecommunications software.

13. The method of claim 9, in which the Internet connected computerized user device runs web browser software, and said Internet connected computerized user device transmits said payment requests to said Internet connected ecommerce server using payment software running in said web browser.

14. The method of claim 13, in which said table is uploaded from a third Internet connected merchant site to said Internet connected computerized user device.

15. A method for splitting and distributing payment of at least one item to the accounts of multiple recipients, using an Internet connected computerized user device, and an Internet connected ecommerce server, comprising:
constructing at least one table of recipients of the proceeds of a payment for said at least one item, said at least one table comprising at least a list of recipients for said proceeds of said payment for at least one item, and a splitting scheme to distribute said proceeds from said payment of said at least one item to said recipients;
transmitting a payment request for said at least one item across said Internet from said Internet computerized user device to said Internet connected ecommerce server;
receiving said payment request for said at least one item at said Internet connected ecommerce server; and automatically distributing said proceeds from said payment request to said recipients according to said table;
in which said ecommerce server receives payment instructions over said Internet using an ecommerce Applications Programming Interface (API) with an ecommerce API protocol, and said Internet connected computerized device sends said payment request to said ecommerce server following said API protocol;
making said ecommerce Applications Programming Interface (API) protocol capable of recognizing and following payment instructions according to said at least one table, and transmitting said at least one table from said Internet connected computerized user device to said ecommerce server along with said payment request; and
in which said Internet computerized user device runs web browser software, and said Internet computerized user device transmits said payment requests to said Internet connected ecommerce server using payment software running in said web browser.

16. The method of claim 15, in which said at least one table is transmitted from a third Internet connected merchant website to said Internet connected ecommerce server.

17. The method of claim 15, in which said at least one table is embedded in an HTML web page that is uploaded from a third Internet connected merchant website to said Internet connected user device prior to said payment.

18. The method of claim 17, in which said at least one table is embedded in a JavaScript code that is in turn embedded in said HTML web page that is uploaded from said third Internet connected merchant website to said Internet connected user device prior to said payment.

19. The method of claim 18, in which said web browser software renders said at least one table in a Graphical User Interface (GUI) of said web browser in a form that hides the table, and that allows the user to initiate said payment by triggering a graphical element on a web page rendered by said web browser.

20. The method of claim 17, in which said at least one table is encrypted.
